(19) United States
(12) Patent Application Publication
(10) Pub. No.: US 2010/0254559 A1
(43) Pub. Date: Oct. 7, 2010

(54) Drum Microphone Mounting Device

(76) Inventor: Robert Heil, Belleville, IL (US)

Correspondence Address: BRYAN CAVE LLP, 211 NORTH BROADWAY, SUITE 3600, ST. LOUIS, MO, 63102-2750, US

(21) Appl. No.: 12/416,707

(22) Filed: Apr. 1, 2009

(51) Int. Cl. H04R 17/02

(52) U.S. Cl. 381/361

(57) ABSTRACT

A device for mounting a microphone includes an elongate coupling plate designed such that the microphone may be adjustably mounted to the plate at a desired location along the length of the coupling plate. The device also includes a clamping assembly for attaching the device to the drum. The clamping assembly is preferably pivotally attached to the coupling plate. The clamping assembly may include a pair of clamping plates to engage the counterhoop of a drum to retain the microphone on the drum.

### FIELD OF THE INVENTION

This invention relates generally to microphones and, in particular, to devices used to mount microphones onto musical instruments such as drum sets.

### BACKGROUND OF THE INVENTION

A number of microphones are commonly used to amplify or record live musical performances involving a number of instruments. In many instances, the microphones are preferably arranged as close to the instruments as possible in order to improve the performance of the microphones. When using a microphone with a drum or set of drums, a microphone holder is commonly used to position and hold the microphone in place.

Free standing microphone stands are frequently used, but the stands are easily knocked over by the performers. In addition, the stands are placed at fixed points and generally too far away from the drum skins, resulting in limited capturing of the sounds by the microphones.

Another alternative involves mounting the microphone to the drum set using a mounting device. Conventional mounting devices, however, are limited in their ability to effectively position the sound capturing end of the microphone at various locations near the skin of the drum. A need exists, therefore, for an improved device for mounting a microphone that permits the sound capturing end of the microphone to be adjusted such that it may be placed adjacent a wide variety of locations along or near the surface of the drum. Preferably, such an improved microphone mounting device would permit the microphone to be mounted close to the skin of the drum to obtain a better sound pick-up effect

### SUMMARY OF THE INVENTION

According to one aspect of the present invention, a device for mounting a drum microphone includes an elongate coupling plate designed such that the microphone may be adjustably mounted to the plate at a desired location along the length of the coupling plate. The device also includes a clamping assembly for attaching the device to the drum. The clamping assembly is preferably pivotally attached to the coupling plate. The clamping assembly may include a pair of clamping plates to engage the counterhoop of a drum to retain the microphone on the drum. Preferably, the mounting device includes a pivot assembly passing through aligned flanges of the coupling plate and the clamping assembly to pivotally attach the coupling plate to the clamping assembly such that the coupling plate may pivot along an axis parallel to the counterhoop at the location of attachment.

### BRIEF DESCRIPTION OF THE FIGURES

These and other features, aspects and advantages of the invention will become more fully apparent from the following detailed description, appended claims, and accompanying drawings, wherein the drawings illustrate features in accordance with an exemplary embodiment of the present invention, and wherein:

FIG. 1 is perspective view of the mounting device of the present invention;

FIG. 2 is a side view of the mounting device;

FIG. 3 is an exploded perspective view of the mounting device;

FIG. 4 is an exploded side view of the mounting device; and

FIGS. 5 and 6 are illustrations showing the use of the mounting device.

### DETAILED DESCRIPTION OF THE INVENTION

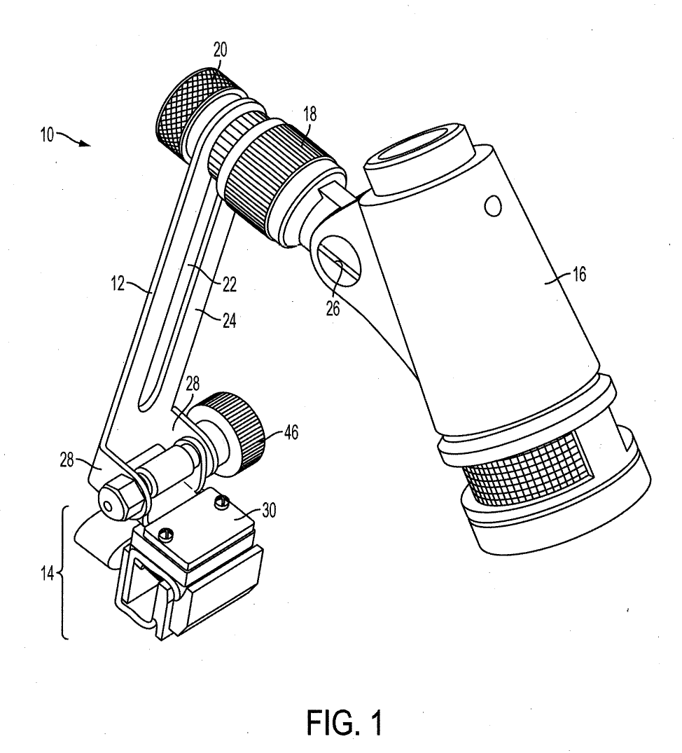

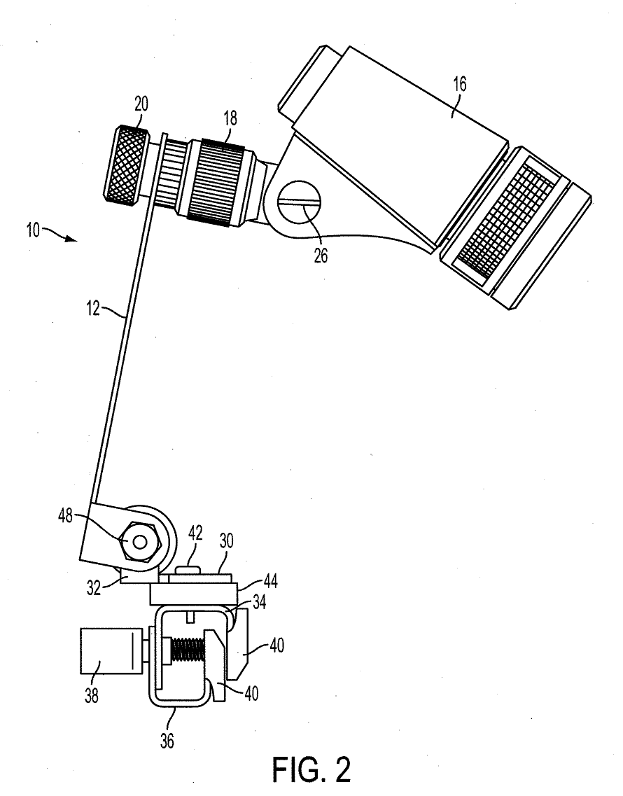

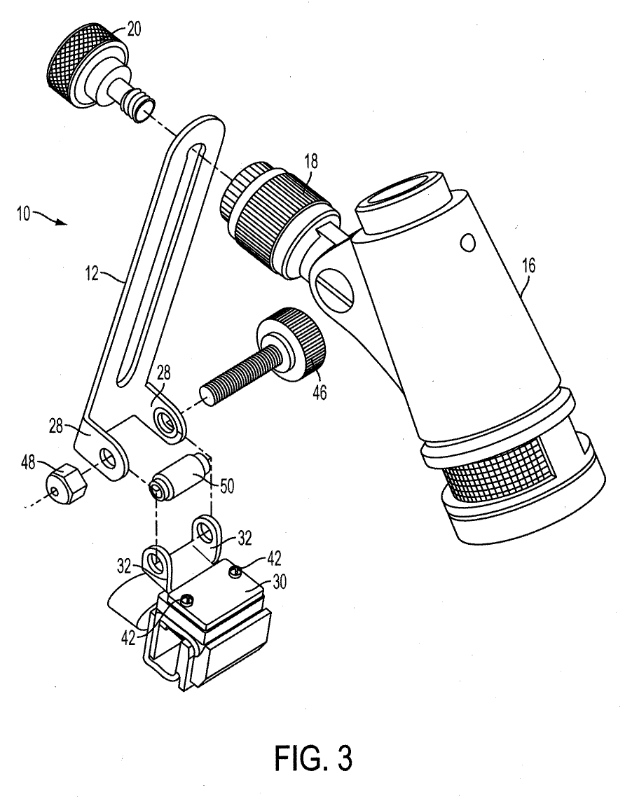

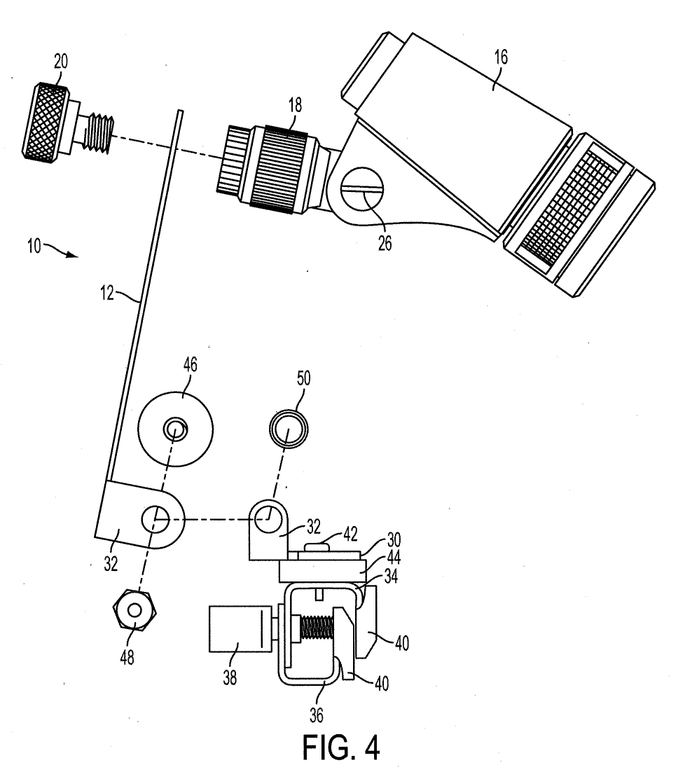

As illustrated in FIGS. 1-4, the mounting device 10 that is preferably adapted to engage the counterhoop of a drum primarily includes an elongate coupling plate 12 and a clamping assembly 14. A conventional microphone 16 may be attached to the coupling plate 12 at a location along the length of the plate 12. For example, the coupling plate 12 may include an elongate coupling slot 22, wherein the microphone 16 may be attached to the plate 12 at a desired location along the length of the coupling slot 22 by using a microphone mounting connector 18 and a threaded bolt 20, in which the bolt 20 engages a threaded hole in the microphone mounting connector 18 to secure the microphone at a desired location. The coupling slot 22 permits extension of the bolt 20 therethrough for locking the microphone mounting connecting 18 to the coupling plate 12. Although the preferred embodiment shown in FIGS. 1-4 illustrates a coupling slot as a means for allowing the microphone 16 to be attached to the coupling plate 12 at various locations along its length, other means may be used to accomplish this goal. For example, a plurality of mounting holes may be included along the length of the coupling plate 12, thereby permitting the microphone to be attached to the plate 12 at a plurality of discrete locations along the length of the plate 12. The coupling plate 12 has an inner side surface 24 that with is adapted to face the drum. The coupling plate 12 may also include flanges 28 extending perpendicular to, and in a direction facing, the inner surface 24 of the plate 12. The length of the coupling plate 12 and coupling slot 22 may be varied depending on the particular application. For example, use of a longer coupling plate 12 with a coupling slot 22 extending to near the distal end of the plate 12 permits the sound capturing end of the microphone to be positioned near the center or interior portion of the drum skin.

The microphone mounting connector may allow the microphone 16 to be positioned and adjusted such that the sound capturing end of the microphone 16 is closer to, farther away, or angled with respect to the surface of the drum skin. For example, the microphone 16 may pivot with respect to the microphone mounting connector 18 at pivot point 26, allowing the sound capturing portion of the microphone 16 to be positioned closer to the surface of the drum. In addition, the microphone 16 may be adjustably swiveled along the center axis of the microphone mounting connector 18 by turning the microphone 16 in the desired rotational direction while the threaded bolt 20 is at least slightly loosened.

The clamping assembly 14 is designed to anchor the mounting device 10 to the drum, for example to the counterhoop of the drum. In one embodiment, the upper portion of the clamping assembly 14 includes bracket 30 having flanges 32 extending perpendicular to the primary upper surface of the bracket 30. The lower portion of the clamping assembly 14 includes a mechanism to attach to the drum. For example, the lower portion may include a vise-like component including a stationary first U-shaped clamping plate 34 and a movable second U-shaped plate 36. The moveable second U- shaped clamping plate 36 can be adjusted by turning the thumb screw 38 such that the moveable second U-shaped clamping plate 36 may move toward the stationary first U- shaped clamping plate 34 to permit the plates to secure the mounting device 10 to a counterhoop of a drum. The distal end of the screw 38 is inserted into a hole in the back side of the second clamping plate 36. Thus, when the thumb screw 38 is turned inwards, the second clamping plate 36 is forced inwards toward the first clamping plate 34. When the thumb screw 38 is turned in the reverse direction, the second clamping plate 36 retreats away from the first plate 34. Therefore, by means of this adjusting procedure, the clamping plates can be firmly secured to the counterhoop of a drum. The two clamping plates 34, 36 may include dampening pads 40 in order to dampen any acoustical vibration from the counterhoop from reaching the microphone 16. Other means for the clamping assembly 14 may also be used to secure the mounting device 10 to the drum, another instrument, or any other object.

The bracket 30 may be attached to the top of the first U-shaped clamping plate 34 using screws 42. A damping pad 44 may be used as a gasket between the bracket 30 and the clamping plate 34.

Preferably, the clamping assembly 14 is pivotally attached to the coupling plate 12 to permit the sound capturing end of the microphone 16 to be positioned in a greater number of locations and angles than conventional drum microphone mounts. For example, the holes in the flanges 28 of the coupling plate 12 may be aligned with the holes in the flanges 32 of the bracket 30 to permit a pivoting assembly including threaded bolt 46 to extend through the aligned holes and secured by end cap nut 48. The pivoting assembly may further include a pivot pin 50 positioned in the space between the flanges 28 to assist in pivotally securing the coupling plate 12 to the clamping assembly 14.

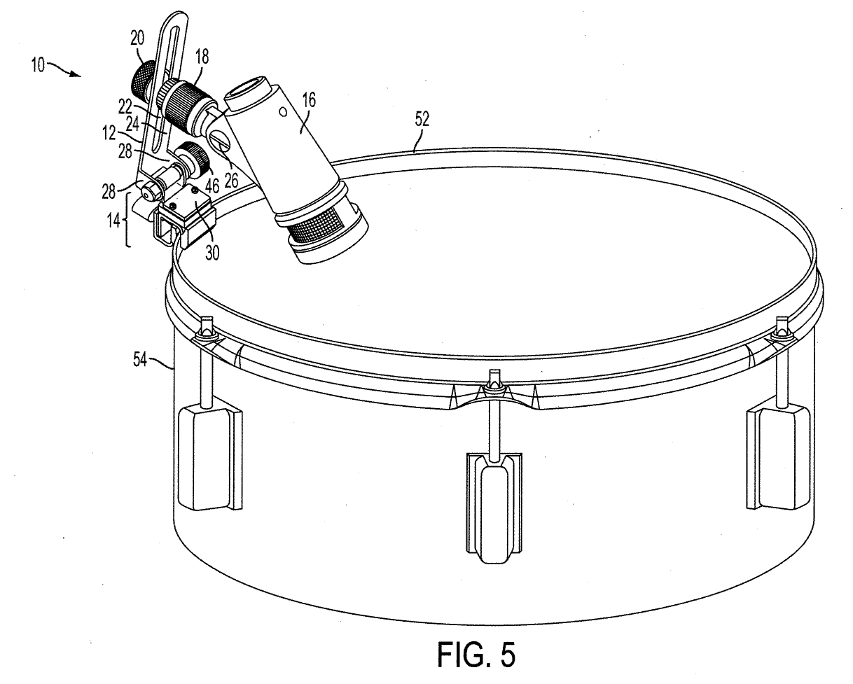

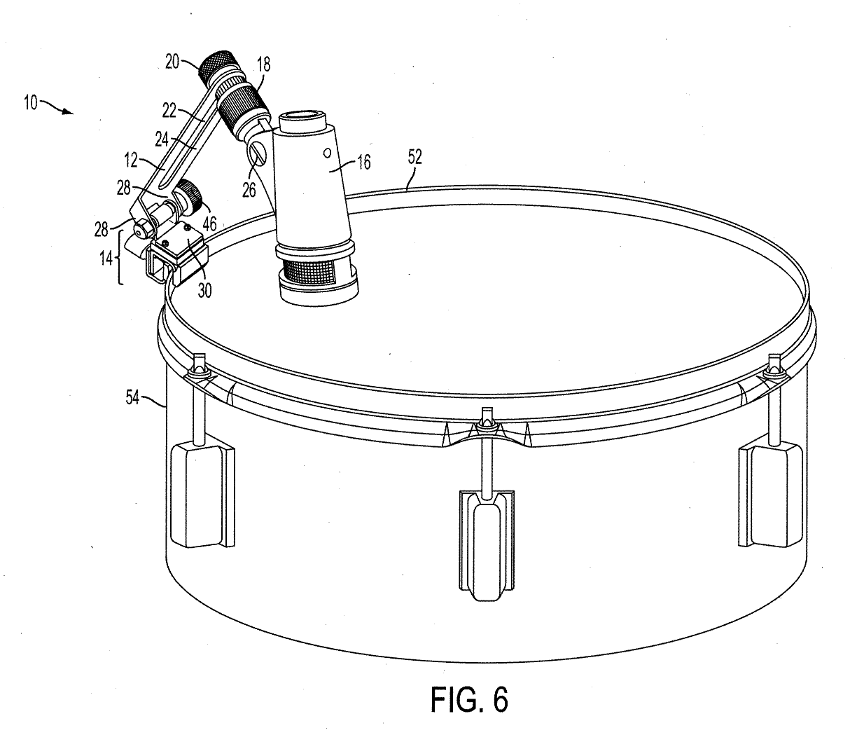

Unlike conventional drum microphone mounting devices, the device 10 described herein, in which the microphone may be adjustably mounted along the length of the coupling plate 12 and in which the coupling plate 12 may be pivotally attached to the clamping assembly 14, allows for a greater adjustment in position and variety of the inclination angle between the sound receiving portion of the microphone 16 and the surface of the drum. For example, FIGS. 5 and 6 illustrates two variations for mounting a drum microphone on a drum 54 such that the sound capturing end of the microphone 16 is placed adjacent different locations on the drum skin. As shown in FIGS. 5 and 6, the coupling plate 12 may be pivoted along an axis parallel to the surface upon which the clamping plates 34 and 36 hold the mounting device 10. The coupling plate 12 may be continuously pivoted with respect to the clamping assembly 14 through a predetermined angular range and may be locked in place at a desired angular position by tension exerted by bolt 46 forcing flanges 28 and flanges 32 together. Although FIGS. 5 and 6 illustrate the microphone mounted to the counterhoop 52 of the drum 54 to permit the sound capturing end of the microphone 16 to be positioned near the top surface of the drum skin, it is readily apparent that the mounting device 10 may be used to position the locate the microphone in other places, for example in the cavity of the underside of the drum 54. In addition, although the drawing illustrates the mounting device 10 for use in connection with a drum microphone, those skilled in the art will recognize that the mounting device 10 of the present invention may be use to amplify sound originating from other instruments, persons or things.

Although certain illustrative embodiments and methods have been disclosed herein, it will be apparent from the foregoing disclosure to those skilled in the art that variations and modifications of such embodiments and methods may be made without departing from the spirit and scope of the invention. Accordingly, it is intended that the invention should be limited only to extent required by the appended claims and the rules and principals of applicable law.

1. A device for mounting a microphone comprising:
a coupling plate having an inner side surface wherein the microphone may be adjustably mounted to the plate at a desired location along the length of the coupling plate; and
a clamping assembly pivotally attached to the coupling plate.

2. The device of claim 1 wherein the coupling plate may continuously pivot with respect to the clamping assembly through a predetermine angular range.

3. The device of claim 1 wherein the microphone is pivotally attached to the coupling plate via a connecting device such that the microphone may be pivoted with respect to the coupling plate.

4. The device of claim 1 wherein the coupling plate comprises an elongate coupling slot and wherein the microphone may be adjustably mounted to the coupling plate at a desired location along the length of the coupling slot.

5. The device of claim 1 wherein the clamping assembly comprises a first clamping plate and a second clamping plate movable with respect to the first clamping plate such that the clamping plates may engage with a counterhoop of a drum to retain the microphone on the drum.

6. The device of claim 5 wherein the coupling plate further comprises a pair of flanges facing the direction of the inner side surface of the coupling plate.

7. The device of claim 6 wherein the clamping assembly further comprises a pair of flanges which align with the flanges of the coupling plate to connect the coupling plate to the clamping assembly.

8. The device of claim 7 further comprising a pivot assembly passing through the aligned flanges of the coupling plate and the clamping assembly to pivotally attach the coupling plate to the clamping assembly.

9. The device of claim 8 wherein the pivot assembly allows the coupling plate to continuously pivot with respect to the clamping assembly through a predetermine angular range.

10. The device of claim 8 wherein the pivot assembly is on an axis that is parallel to the first and second clamping plates.

11. A device for mounting a microphone to a counterhoop of a drum comprising:
a coupling plate having an inner side surface wherein the microphone may be adjustably mounted to the plate at a desired location along the length of the coupling plate; and
a clamping assembly for attaching the device to the counterhoop, wherein the clamping assembly is pivotally attached to the coupling plate.

12. The device of claim 11 wherein the coupling plate may continuously pivot with respect to the clamping assembly through a predetermine angular range.

13. The device of claim 11 wherein the microphone is pivotally attached to the coupling plate via a connecting device such that the microphone may be pivoted with respect to the coupling plate.

14. The device of claim 11 wherein the coupling plate comprises an elongate coupling slot and wherein the microphone may be adjustably mounted to the coupling plate at a desired location along the length of the coupling slot.

15. The device of claim 11 wherein the clamping assembly comprises a first clamping plate and a second clamping plate movable with respect to the first clamping plate such that the clamping plates may engage with the counterhoop to retain the microphone on the drum.

16. The device of claim 15 wherein the coupling plate further comprises a pair of flanges facing the direction of the inner side surface of the coupling plate.

17. The device of claim 16 wherein the clamping assembly further comprises a pair of flanges which align with the flanges of the coupling plate to connect the coupling plate to the clamping assembly.

18. The device of claim 17 further comprising a pivot assembly passing through the aligned flanges of the coupling plate and the clamping assembly to pivotally attach the coupling plate to the clamping assembly.

19. The device of claim 18 wherein the pivot assembly allows the coupling plate to continuously pivot with respect to the clamping assembly through a predetermine angular range.

20. The device of claim 18 wherein the pivot assembly is on an axis that is parallel to the first and second clamping plates such that the coupling plate pivots on an axis parallel to the counterhoop at the location of attachment.
